(19) United States
(12) Patent Application Publication
(10) Pub. No.: US 2018/0226736 A1
(43) Pub. Date: Aug. 9, 2018

(54) ELECTRICAL CONNECTOR

(71) Applicant: DAI-ICHI SEIKO CO.,LTD., Kyoto-shi (JP)

(72) Inventor: Takeshi HIRAKAWA, Machida-city (JP)

(73) Assignee: DAI-ICHI SEIKO CO.,LTD., Kyoto-shi (JP)

(21) Appl. No.: 15/888,098

(22) Filed: Feb. 5, 2018

(30) Foreign Application Priority Data
Feb. 7, 2017 (JP) 2017-020520

(51) Int. Cl. H01R 12/77; H01R 12/71; H01R 13/639

(52) U.S. Cl. CPC H01R 12/774; H01R 13/639; H01R 12/716

(57) ABSTRACT

A electrical connector includes a receptacle connector electrically connected to a wiring substrate and a locking member mounted on the receptacle connector to hold a fit state with respect to a plug connector corresponding to a counterpart connector. The receptacle connector includes a connector engaging portion that is engaged with the locking member, and the locking member includes a main body interposing the plug connector fit to the receptacle connector between the main body and the receptacle connector at a time of being mounted on the receptacle connector. A lock engaging portion is engaged with the connector engaging portion in a state in which the plug connector is interposed between the receptacle connector and the main body.

### CROSS-REFERENCE TO RELATED APPLICATION

This application is based upon and claims the benefit of priority from Japanese Patent Application No. 2017-020520, filed on Feb. 7, 2017, the entire contents of which are incorporated herein by reference.

### TECHNICAL FIELD

The present disclosure relates to an electrical connector.

### BACKGROUND

For electrical connectors mounted on a substrate, it is important to securely maintain a connection state in which a conductive contact of one electrical connector and a conductive contact of another electrical connector corresponding to a counterpart connector are electrically connected to each other. For example, in an electrical connector assembly described in Japanese Unexamined Patent Publication No. 2016-167467, electrical connectors are connected to each other when a convex fitting portion of one electrical connector is fit into a concave receiving portion of the other electrical connector.

### SUMMARY

However, for electrical connectors mounted on a substrate, a connection state may not be sufficiently maintained merely by fitting the electrical connectors to each other. Therefore, the disclosure describes an electrical connector configured to securely maintain a connection state.

An example electrical connector according to the disclosure includes a first connector electrically connected to a first substrate, and a locking member mounted on the first connector to hold a fit state between the first connector and a second connector corresponding to a counterpart electrical connector, in which the first connector includes a connector engaging portion configured to be engaged with the locking member. The locking member includes a main body, and the second connector is interposed between the main body and the first connector when the second connector is mounted on the first connector. The locking member further includes a lock engaging portion configured to be engaged with the connector engaging portion when the second connector is interposed between the first connector and the main body.

In some examples electrical connectors according to the disclosure, when the second connector is interposed between the main body of the locking member and the first connector, the lock engaging portion of the locking member may be engaged with the connector engaging portion of the first connector. In this way, the locking member and the first connector are connected to each other when the second connector is interposed therebetween, and a connection state between the first connector and the second connector may be more securely maintained as compared to a case in which the first connector and the second connector are merely fit together without a locking member.

The first connector may include a plurality of conductive contacts, and two connector engaging portions. A connector engaging portion may be located at each end (both ends) of the first connector in an array direction of the plurality of contacts. The locking member may include two lock engaging portions. A lock engaging portion may be located at each end (both ends) of the main body of the locking member. The two lock engaging members of the locking member may be configured to be engaged with the two connector engaging portions of the first connector at each end of the first connector and/or at each end of the main body. When the sets of lock engaging portions provided at the respective ends of the first connector and the locking member are engaged with each other, the first connector and the locking member are connected by a stronger force, and the connection state between the first connector and the second connector may be more securely maintained.

The second connector and a second substrate to which the second connector is electrically connected may be interposed between the main body and the first connector when the main body of the locking member is mounted on the first connector. The main body of the locking member may include a contact portion configured to come into contact with the second substrate before the lock engaging portion is engaged with the connector engaging portion. Additionally, the main body of the locking member may include an elastic portion configured to elastically deform such that the lock engaging portion is disposed at an engagement position with respect to the connector engaging portion when the contact portion comes into contact with the second substrate. In this way, in the locking member, the lock engaging portion is engaged with the connector engaging portion in a state in which the main body is elastically deformed. In this way, the lock engaging portion in a tensioned state may be engaged with the connector engaging portion, and the first connector and the locking member are connected by a stronger force. As a result, the connection state between the first connector and the second connector may be more securely maintained.

A thickness of the contact portion may be thicker than a thickness of the main body other than the contact portion or, in other words, the contact portion may be the thickest portion of the main body. In this way, the contact portion may be easily brought into contact with the second substrate. Accordingly, in some example embodiments, the contact portion is brought into contact with the second substrate before the lock engaging portion is engaged with the connector engaging portion and the elastic portion is elastically deformed as a result of the initial contact.

At least a portion of the contact portion may be provided at a central portion of the main body in an opposing direction of a pair of lock engaging portions, and the elastic portion may be provided between the contact portion and each of the lock engaging portions in the opposing direction (lengthwise direction) of the main body. In this way, the elastic portion and the lock engaging portion are provided close to each other at both ends (both halves) of the main body. When the elastic portions provided at both ends of the main body are elastically deformed, tension may be favorably applied to the lock engaging portions at both ends, and the connection state between the first connector and the second connector may be more securely maintained.

The second connector and a second substrate to which the second connector is electrically connected are interposed between the main body and the first connector when the main body is mounted on the first connector. The locking member may further include guide portions that guide movement of the lock engaging portion along the second substrate, and the lock engaging portion may be engaged with the connector engaging portion by moving in accordance with guidance of the guide portion. In this way, the lock engaging portion may be engaged with the connector engaging portion by being moved in a direction intersecting the fitting direction of the first connector and the second connector, that is, the direction along the second substrate. In this way, when the lock engaging portion is engaged in a different direction from the fitting direction of the first connector and the second connector, an engagement operation is facilitated, and the connection state between the first connector and the second connector may be more securely maintained.

The locking member may further include one or more regulation portions that regulate further movement of the lock engaging portion in a direction in which the lock engaging portion moves. In some examples, the regulation members are configured to regulate or prohibit movement of the lock engaging portion when the lock engaging portion is engaged with the connector engaging portion. In this way, the lock engaging portion is inhibited from moving beyond the engagement position with respect to the connector engaging portion, and the lock engaging portion may be appropriately positioned with respect to the connector engaging portion.

The guide portions may include a pair of wall portions that extends in the direction in which the lock engaging portion moves and interpose, or are located to the outside of, the connector engaging portions in the opposing direction of the pair of connector engaging portions. Each of the wall portions may include a projection protruding toward the connector engaging portion, and the connector engaging portion may include a recess into which the projection is fit when the lock engaging portion is engaged with the connector engaging portion. When the projection is fit into the recess, the lock engaging portion may be appropriately positioned with respect to the connector engaging portion, giving a click feeling to an operator, and allowing the operator to detect engagement.

A length of the lock engaging portion in the direction in which the lock engaging portion moves may be shorter than a length of the main body in the direction in which the lock engaging portion moves. When the length of the lock engaging portion is short, a moving distance of the lock engaging portion may be decreased in accordance with the guide portion, and the locking member may be mounted with respect to the first connector even in a limited space.

The lock engaging portion may be disposed at a rear end of the locking member in the direction in which the lock engaging portion moves. In this way, the lock engaging portion may be moved by the length of the lock engaging portion provided at the rear end, and the locking member may be mounted with respect to the first connector in a more limited space.

The second substrate may be mounted with the second connector at one end of the second substrate in an extending or lengthwise direction. The lock engaging portion may be configured to move in the extending direction of the second substrate from the other end to the one end in accordance with guidance of the guide portions. In this way, the lock engaging portion is initially disposed at the other end of the locking member at which the second substrate extends. For example, in a case in which the second substrate is set to a flexible printed circuit (FPC), the other end of the second substrate may be raised in some cases. In this case, an extraction force due to tilting may be inadvertently applied to the locking member by the raised second substrate. On the other hand, when the position of the lock engaging portion in the locking member is set to the other end in the extending direction of the second substrate, the locking member may be inhibited from being detached from the first connector due to extraction by tilting.

The main body may include a first contact portion that comes into contact with the second substrate before engagement of the lock engaging portion and the connector engaging portion is completed. Additionally, the main body may include a second contact portion that comes into contact with the second substrate when engagement of the lock engaging portion and the connector engaging portion is completed. A thickness of the second contact portion may be greater than a thickness of the first contact portion. In a step before engagement is completed, that is, in a state in which the locking member moves with respect to the first connector, smooth movement of the locking member is allowed by the first contact portion having a relatively small thickness coming into contact with the second substrate. In a step in which engagement is completed, the second substrate may be favorably pressed by the main body at the time of engagement by the second contact portion having a relatively large thickness coming into contact with the second substrate.

The first contact portion may be formed in an inclined shape to become gradually thicker from a front side toward a rear side in the direction in which the lock engaging portion moves. In this way, i a configuration may be adopted in which a pressing force on the second substrate by the first contact portion is small at the time of starting movement, and the pressing force on the second substrate by the first contact portion is gradually increased as movement progresses. In this way, movement of the locking member becomes smoother, and movement of the locking member may be favorably performed with respect to the first connector.

The first connector may further include a fixed metal fitting used for fixing the first connector to the first substrate. In some example embodiments, both the lock engaging portion and the connector engaging portion may contain resin. Additionally, the fixed metal fitting may be included in a part of the connector engaging portion. When the fixed metal fitting used to fix the first connector to the first substrate is caused to function as the part of the connector engaging portion, the strength of the connector engaging portion may be improved, and the engagement strength of the lock engaging portion and the connector engaging portion may be strengthened.

A through-hole may be formed in the main body such that the lock engaging portion is visually recognizable. In this way, the appropriate engagement of the lock engaging portion with the connector engaging portion may be visually recognized from the through-hole.

The first connector may be a receptacle connector including an accommodating portion configured to accommodate the second connector, and the second connector may be a plug connector that is fit to the first connector by being accommodated in the accommodating portion. In this way, a connection state between the plug connector mounted on the substrate and the receptacle connector may be securely maintained by using the locking member.

Accordingly, example electrical connectors configured to securely maintain a connection state are disclosed herein.

### BRIEF DESCRIPTION OF THE DRAWINGS

FIG. 1 is a perspective view of an electrical connector according to a first group of example embodiments of the invention;

FIGS. 2A to 2D are diagrams schematically illustrating a mounting procedure of the electrical connector of FIG. 1, FIG. 2A is a perspective view illustrating a state before a plug connector and a receptacle connector are fit together, FIG. 2B is a perspective view illustrating a fit state of the plug connector and the receptacle connector, FIG. 2C is a perspective view illustrating a state in which a locking member is mounted, and FIG. 2D is a perspective view illustrating the state in which the locking member is mounted;

FIGS. 3A to 3E are diagrams illustrating the receptacle connector included in the electrical connector of FIG. 1, FIG. 3A is a plan view, FIG. 3B is a front view, FIG. 3C is a bottom view, FIG. 3D is a perspective view, and FIG. 3E is a perspective view in a different direction from that of FIG. 3D;

FIGS. 4A to 4E are diagrams illustrating the plug connector included in the electrical connector of FIG. 1, FIG. 4A is a plan view, FIG. 4B is a front view, FIG. 4C is a bottom view, FIG. 4D is a perspective view, and FIG. 4E is a perspective view in a different direction from that of FIG. 4D;

FIGS. 5A to 5D are diagrams illustrating the fit state of the receptacle connector and the plug connector, FIG. 5A is a plan view, FIG. 5B is a front view, FIG. 5C is a perspective view, and FIG. 5D is a cross-sectional view taken along (D)-(D) line of FIG. 5A;

FIGS. 6A to 6F are diagrams illustrating the locking member included in the electrical connector of FIG. 1, FIG. 6A is a plan view, FIG. 6B is a front view, FIG. 6C is a bottom view, FIG. 6D is a cross-sectional view taken along (D)-(D) line of FIG. 6A, FIG. 6E is a perspective view, and FIG. 6F is a perspective view in a different direction from that of FIG. 6E;

FIGS. 7A to 7C are diagrams illustrating the state in which the locking member is mounted, FIG. 7A is a plan view, FIG. 7B is a bottom view, and FIG. 7C is an enlarged cross-sectional view taken along (C)-(C) line of FIG. 7A;

FIGS. 8A and 8B are diagrams illustrating an example connection configuration of electrical connectors mounted on a substrate, FIG. 8A is a perspective view illustrating a state before fitting of the electrical connectors, and FIG. 8B is a perspective view illustrating a state after fitting of the electrical connectors;

FIG. 9 is a perspective view illustrating an electrical connector according to a second group of example embodiments of the invention;

FIGS. 10A to 10F are diagrams illustrating a locking member included in the electrical connector of FIG. 9, FIG. 10A is a plan view, FIG. 10B is a front view, FIG. 10C is a bottom view, FIG. 10D is a cross-sectional view taken along (D)-(D) line of FIG. 10B, FIG. 10E is a perspective view, and FIG. 1OF is a perspective view in a different direction from that of FIG. 10E; and

FIGS. 11A to 11C are diagrams illustrating a state in which the locking member is mounted, FIG. 11A is a plan view, FIG. 11B is a bottom view, and FIG. 11C is an enlarged cross-sectional view taken along (C)-(C) line of FIG. 11A.

### DETAILED DESCRIPTION

Embodiments according to the disclosure described below are examples for description of the invention, and thus the invention should not be limited to the examples.

[First Group of Example Embodiments]

Hereinafter, a first group of example embodiments will be described in detail with reference to drawings. In the description, the same reference numeral will be assigned to an element having the same element or the same function, and a repeated description will be omitted.

(Outline of Electrical Connector)

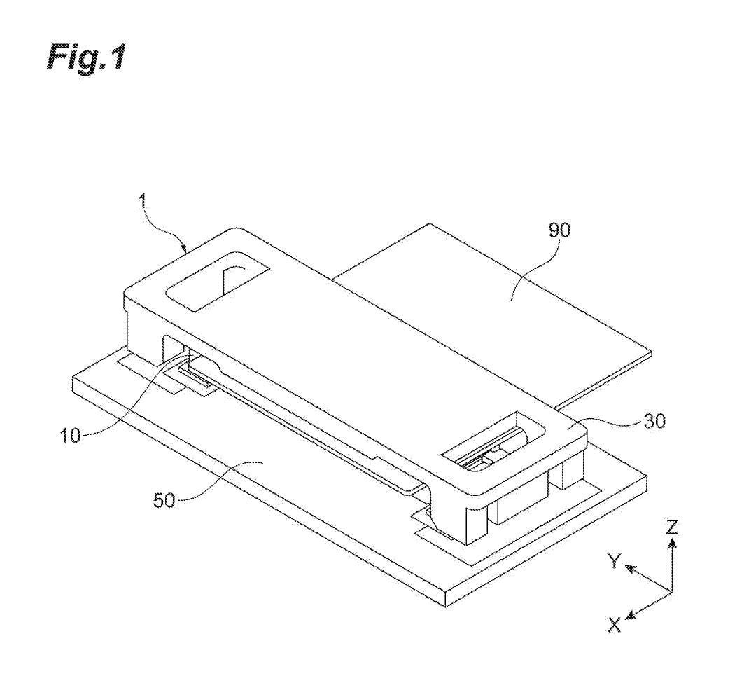

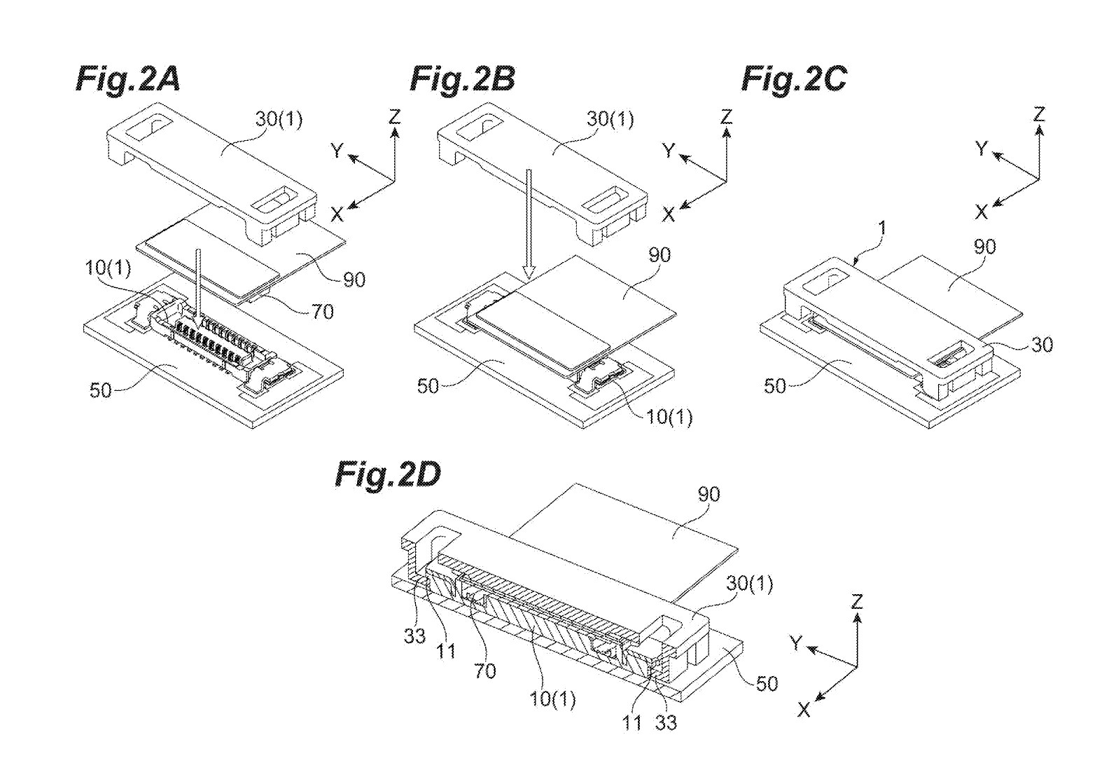

An outline of an example electrical connector will be described with reference to FIG. 1 and FIGS. 2A to 2D. As illustrated in FIG. 1 and FIGS. 2A to 2D, an electrical connector 1 includes a receptacle connector 10 (first connector) and a locking member 30 mounted on the receptacle connector 10 to hold a fit state between the receptacle connector 10 and a plug connector 70 (second connector).

The receptacle connector 10 is electrically connected to a wiring substrate 50 (first substrate). The plug connector 70 is electrically connected to a wiring substrate 90 (second substrate) different from the wiring substrate 50 (see FIG. 2A). The receptacle connector 10 is mounted at one end of the wiring substrate 90 in an extending or lengthwise direction by solder connection, etc. The electrical connector 1 is a connector used for so-called substrate-to-substrate connection that connects the wiring substrates 50 and 90 to each other. Various substrates mounted with electronic circuits may be used as the wiring substrates 50 and 90. In some example embodiments, the wiring substrate 50 corresponds to a printed circuit board and the wiring substrate 90 corresponds to an FPC.

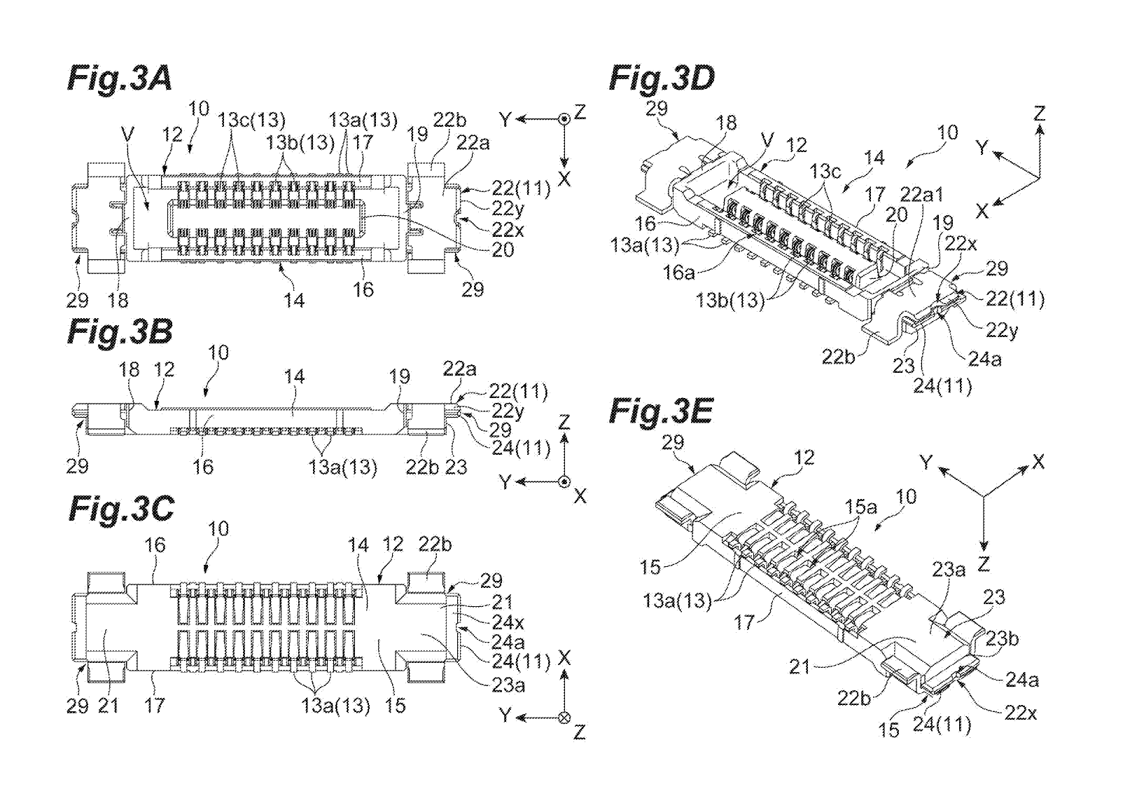

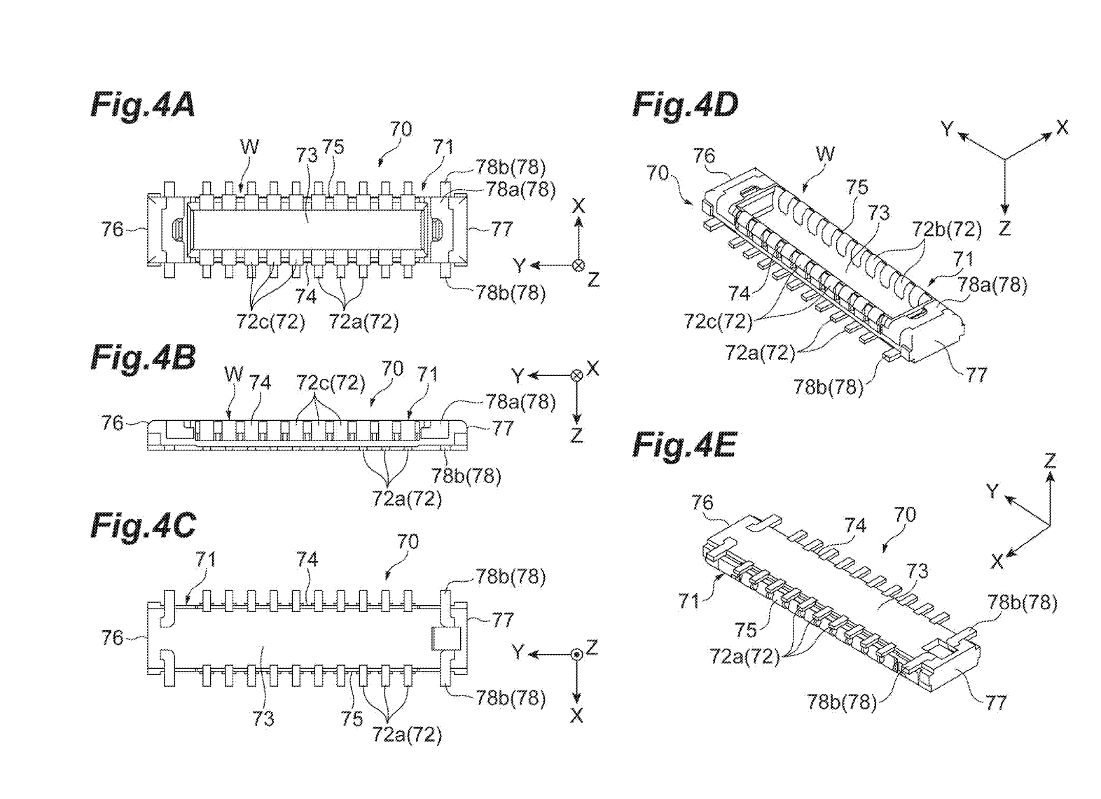

As illustrated in FIGS. 2A to 2C, as a mounting procedure of the electrical connector 1, first, the plug connector 70 mounted on the wiring substrate 90 is fit to the receptacle connector 10 mounted on the wiring substrate 50 (see FIGS. 2A and 2B). Subsequently, the locking member 30 is mounted on the receptacle connector 10 by interposing the plug connector 70 and the wiring substrate 90 between the locking member 30 and the receptacle connector 10 (see FIGS. 2B and 2C). In a state in which the locking member 30 is mounted on the receptacle connector 10, as illustrated in FIG. 2D, a connector engaging portion 11 of the receptacle connector 10 and a lock engaging portion 33 (described below) of the locking member 30 are engaged with each other. In this way, a force in a fitting direction (connecting direction) is applied to the receptacle connector 10 and the plug connector 70 by the locking member 30, and a fit state (connection state) is securely maintained between the receptacle connector 10 and the plug connector 70. A conductive terminal 13 (see FIG. 3A) of the receptacle connector 10 is connected to an electrode of the wiring substrate 50, and a conductive terminal 72 (see FIG. 4A) of the plug connector 70 is connected to an electrode of the wiring substrate 90. When the plug connector 70 is fit to the receptacle connector 10, the conductive terminal 13 of the receptacle connector 10 and the conductive terminal 72 of the plug connector 70 are in contact with each other, and the wiring substrates 50 and 90 are electrically connected to each other. That is, the electrical connector l has a function of electrically and physically connecting the wiring substrates 50 and 90.

In some example embodiments a fitting direction of the receptacle connector 10 and the plug connector 70 is set to a “Z direction”, a longitudinal direction of the receptacle connector 10 and the locking member 30 corresponding to a direction intersecting with the Z direction is set to a “Y direction”, and a width direction of the receptacle connector 10 and the locking member 30 corresponding to a direction intersecting with the Z direction and the Y direction is set to an “X direction”.

(Receptacle Connector)

Next, details of the receptacle connector 10 will be described. In the description of the receptacle connector 10, in some example embodiments, the wiring substrate 50 side with respect to the receptacle connector 10 in the Z direction corresponds to “down” and the opposite side thereof corresponds to “up”. As illustrated in FIGS. 3A to 3E, the receptacle connector 10 is a connector having an accommodating recess V (accommodating portion) configured to accommodate the plug connector 70. The receptacle connector 10 includes a housing 12 and a plurality of conductive terminals 13 (a plurality of conductive contacts). The housing 12 includes a main body 14 and fixing portions 29 and 29 contiguously provided at both ends of the main body 14 in the Y direction. First, a description will be given of the main body 14 of the housing 12 and the plurality of conductive terminals 13, and then a description will be given of the fixing portion 29.

In some example embodiments, the main body 14 is made of an insulating material containing a resin. The main body 14 has a shape of a substantially rectangular parallelepiped extending in a predetermined direction. The main body 14 includes a bottom wall portion 15, side wall portions 16 to 19, and a center wall portion 20.

The bottom wall portion 15 is a plate-shaped body having a substantially rectangular shape. The bottom wall portion 15 has a through-hole 15a having a size corresponding to a shape of the conductive terminal 13 in a region in which the conductive terminal 13 is provided (see FIG. 3E). That is, a number of through-holes 15a which penetrate the bottom wall portion 15 in the Z direction and are equal in number to the conductive terminals 13, are formed in the bottom wall portion 15.

Each of the side wall portions 16 to 19 is provided on the bottom wall portion 15 in an upright state with respect to the bottom wall portion 15. Each of the side wall portions 16 and 17 is located near each long side of the bottom wall portion 15 and extends in the Y direction along the long side. Each of the side wall portions 18 and 19 is located near each short side of the bottom wall portion 15 and extends in the X direction along the short side. For this reason, the side wall portions 16 and 17 oppose each other, and the side wall portions 18 and 19 oppose each other.

The center wall portion 20 is provided on the bottom wall portion 15 in an upright state with respect to the bottom wall portion 15. The center wall portion 20 is located inside a space surrounded by the side wall portions 16 to 19 while being spaced apart from the side wall portions 16 to 19. The center wall portion 20 extends in the Y direction along the long side of the bottom wall portion 15. For this reason, the center wall portion 20 opposes the side wall portions 16 and 17. The accommodating recess V is formed by a space surrounded by the bottom wall portion 15, the side wall portions 16 to 19, and the center wall portion 20 (see FIG. 3D). Therefore, the accommodating recess V has a rectangular annular shape. The accommodating recess V is a space accommodating the plug connector 70.

A plurality of conductive terminals 13 (e.g., ten conductive terminals) is attached to the side wall portion 16. For this reason, on the side wall portion 16, the plurality of conductive terminals 13 is aligned in a row in an extending direction thereof (Y direction). Another plurality of conductive terminals 13 (e.g., ten conductive terminals) is similarly attached to the side wall portion 17. Configurations of these conductive terminals 13 are identical to each other. Thus, hereinafter, the conductive terminals 13 on the side wall portion 16 will be described, and a description of the conductive terminals 13 on the side wall portion 17 will be omitted.

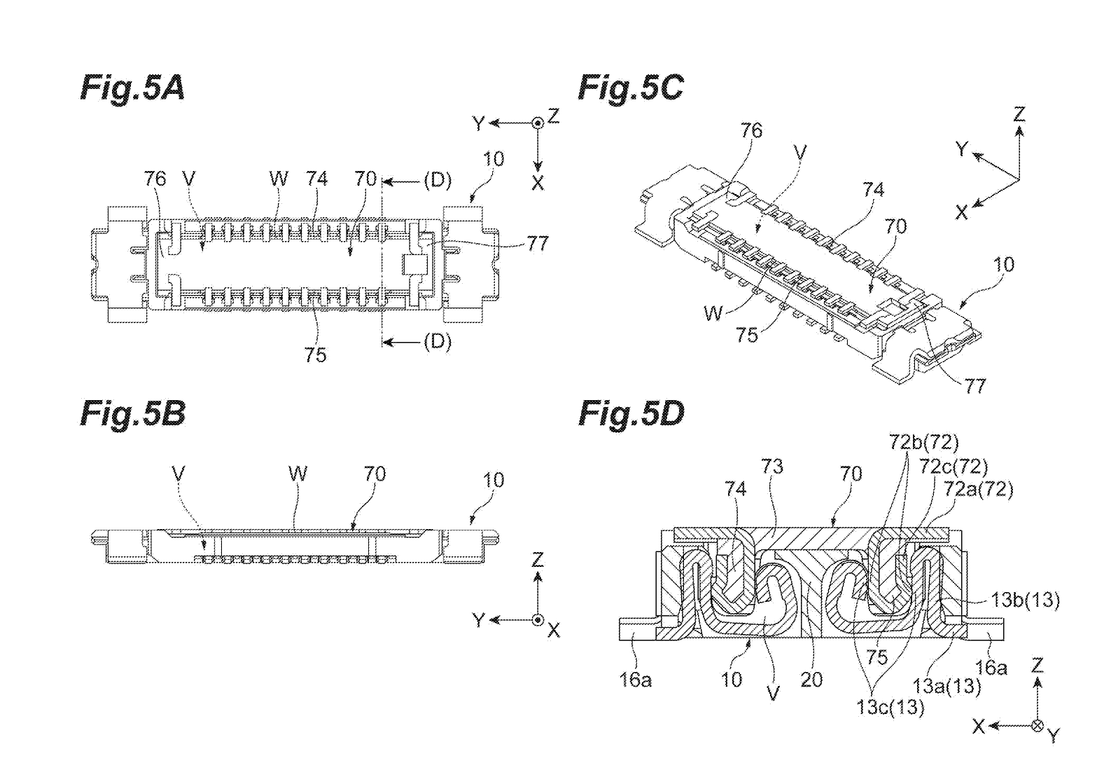

The conductive terminal 13 includes a plate-shaped conductive material (for example, a metal member). The conductive terminal 13 includes a proximal end 13a, an intermediate portion 13b, and a contact portion 13c (see FIGS. 3A to 3E and FIG. 5D). The proximal end 13a is located near the bottom wall portion 15, and extends outward in the X direction from the side wall portion 16. The proximal end 13a is connected to the electrode of the wiring substrate 50 (not illustrated) by solder, etc. when the receptacle connector 10 is mounted on the wiring substrate 50. The intermediate portion 13b continues to the proximal end 13a and extends upward in the Z direction along the side wall portion 16. The intermediate portion 13b is fixed to a groove 16a (see FIG. 3D) formed in the side wall portion 16 by press-fitting. The contact portion 13c continues from the intermediate portion 13b and is located inside the accommodating recess V to come into contact with a contact portion 72b of the conductive terminal 72 of the plug connector 70. An end of the contact portion 13c on the opposite side from a side continued from the intermediate portion 13b is located near the center wall portion 20. As illustrated in FIG. 5D, the contact portion 13c comes into contact with each contact portion 72b of the conductive terminal 72 disposed in the side wall portion 74 of the plug connector 70 at two positions, including a first position corresponding to a side that extends from the intermediate portion 13b and a second position located near the center wall portion 20.

The fixing portions 29 and 29 are contiguous to both ends of the main body 14 in the Y direction, that is, the side wall portion 18 and the side wall portion 19. Configurations of the fixing portions 29 and 29 provided at outer sides of the side wall portion 18 and the side wall portion 19 in the Y direction (the side away from a center of the main body 14 in the Y direction) are identical to each other. Thus, hereinafter, the fixing portion 29 provided at the outer side of the side wall portion 19 in the Y direction will be described, and a description of the fixing portion 29 provided at the outer side of the side wall portion 18 in the Y direction will be omitted.

The fixing portion 29 includes a base portion 21 integrally molded so as to be contiguous to an end of the main body 14 of the housing 12. Additionally the fixing portion 29 includes a fixed metal fitting 22 which covers an upper part of the base portion 21 and is fixed to the wiring substrate 50. In some examples, the base portion 21 is integrally molded with the housing 12 and is made of an insulating material containing resin. The base portion 21 includes an extension portion 23 which is provided contiguously with the side wall portion 19 and has a shape of a substantially rectangular parallelepiped. Additionally, the base portion 21 includes a protruding piece 24 that protrudes outward in the Y direction from an upper end 23b of the extension portion 23. The protruding piece 24 and the fixed metal fitting 22 are included in a part of the connector engaging portion 11.

The extension portion 23 is contiguously provided at a central portion of the side wall portion 19 in the X direction, a bottom surface 23a thereof is substantially flush with the bottom wall portion 15 (see FIG. 3C), and the extension portion 23 is formed to have a height lower than the side wall portion 19 in order to mount the fixed metal fitting 22 to the extension portion 23 (see FIG. 3B). The extension portion 23 is formed such that a length in the X direction on the bottom surface 23a is shorter than a length in the X direction at the upper end 23b (see FIG. 3E).

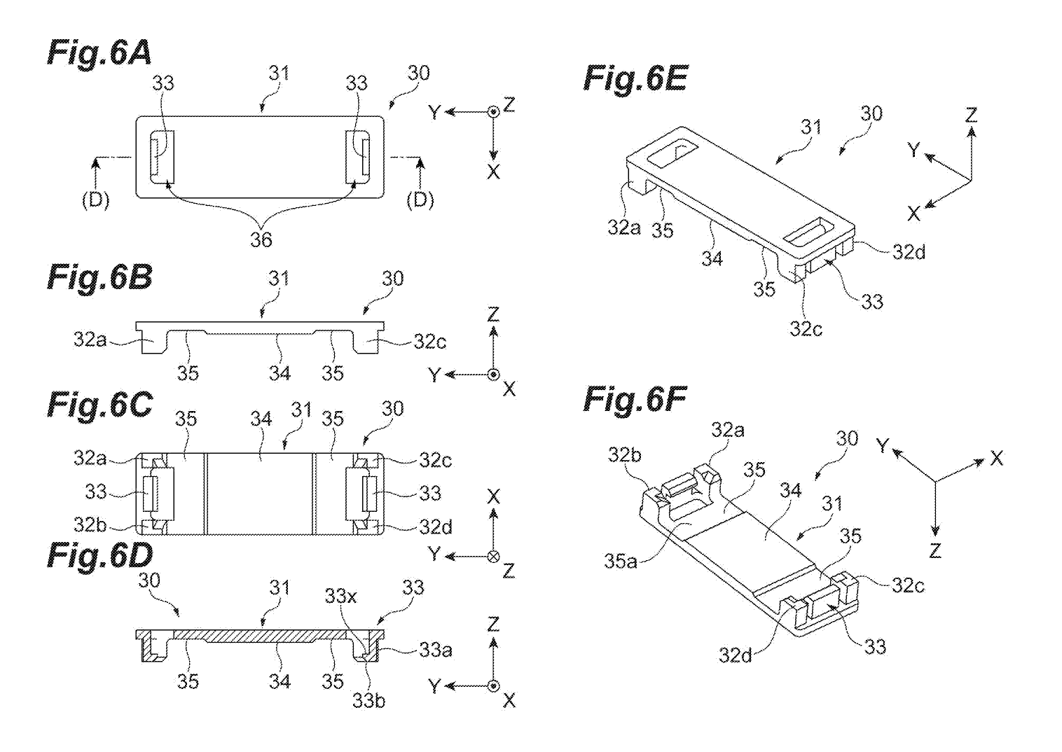

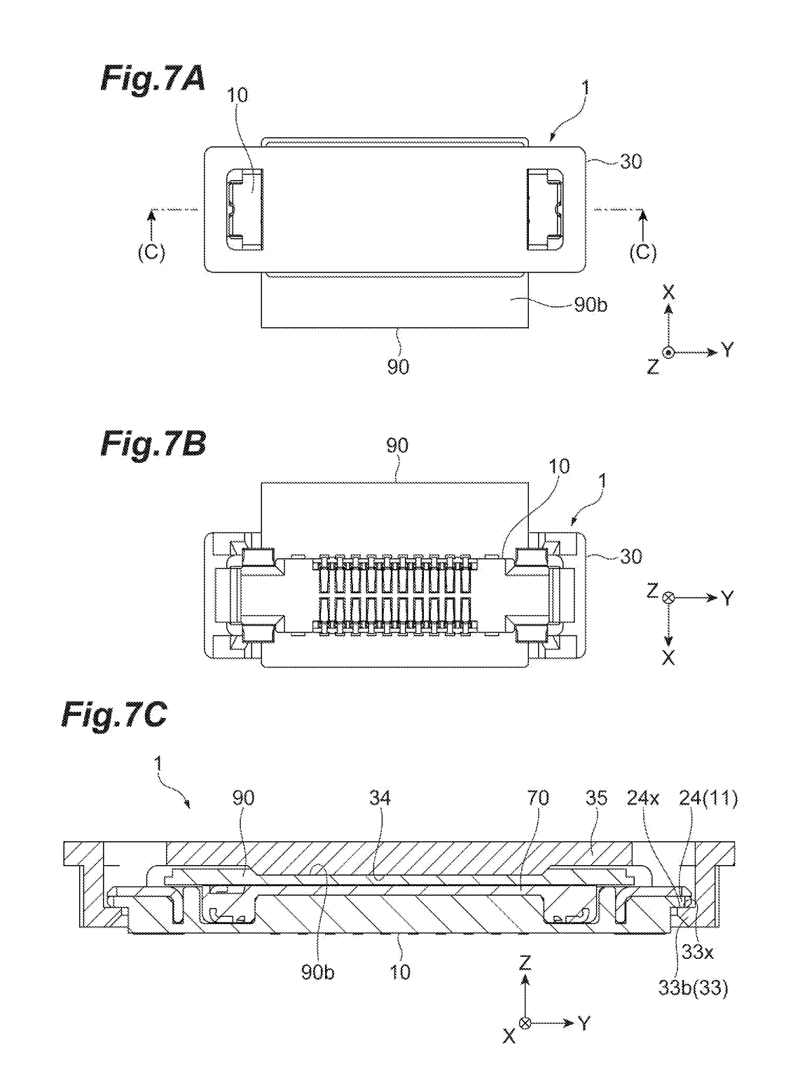

The protruding piece 24 protrudes outward in the Y direction from a substantially whole length of the upper end 23b of the extension portion 23 in the X direction (see FIG. 3E). As illustrated in FIG. 7C, a lower surface 24x (see FIG. 3C) of the protruding piece 24 comes into contact with an upper surface 33x of a protrusion 33b (see FIG. 6D) of the lock engaging portion 33 when the connector engaging portion 11 of the receptacle connector 10 is engaged with the lock engaging portion 33 (see FIGS. 4A to 4E) of the locking member 30. A recess 24a (see FIG. 3D) that is recessed inward in the Y direction (a side approaching the center of the main body 14 in the Y direction) is formed at a substantially central portion of the protruding piece 24 in the X direction.

The fixed metal fitting 22 fixes the receptacle connector 10 to the wiring substrate 50 by covering the upper part of the base portion 21 and being fixed to the wiring substrate 50. For example, the fixed metal fitting 22 includes a thin plate-shaped metal member. The fixed metal fitting 22 includes a cover 22a that covers the base portion 21 and a connection portion 22b is contiguous to both ends of the cover 22a in the X direction. The connection portion 22b is connected to a surface of the wiring substrate 50 by extending downward toward the wiring substrate 50. The cover 22a covers substantially the whole region of an upper surface of the extension portion 23 and an upper surface of the protruding piece 24 included in the base portion 21. A recess 22x that is recessed inward in the Y direction is formed at a substantially central portion in the X direction of a distal end 22y covering the protruding piece 24 in the cover 22a (see FIG. 3A). A formation position of the recess 22x substantially coincides with a formation position of the recess 24a of the protruding piece 24 in the X direction.

The receptacle connector 10 includes connector engaging portions 11 and 11 that can be engaged with the lock engaging portion 33 of the locking member 30. The connector engaging portions 11 and 11 are provided at both ends of the receptacle connector 10, in the Y direction corresponding to an array direction of the plurality of conductive terminals 13, and include the above-described protruding piece 24 and the distal end 22y of the fixed metal fitting 22. In this way, the fixed metal fitting 22 is included in a part of the connector engaging portion 11.

(Plug Connector)

Next, a description will be given of details of the plug connector 70 with reference to FIGS. 4A to 4E. The plug connector 70 is a connector that is fit to the receptacle connector 10 by being accommodated in the accommodating recess V of the receptacle connector 10. The plug connector 70 includes a housing 71 and a plurality of conductive terminals 72.

In some example embodiments, the housing 71 is made of an insulating material containing a resin. The housing 71 has a shape of a substantially rectangular parallelepiped extending in a predetermined direction. The housing 71 includes a bottom wall portion 73 and side wall portions 74 to 77. The bottom wall portion 73 corresponds to a plate-shaped body having a substantially rectangular shape.

Each of the side wall portions 74 to 77 is provided on the bottom wall portion 73 in an upright state with respect to the bottom wall portion 73. The side wall portions 74 to 77 are accommodated in the accommodating recess V of the receptacle connector 10 when the plug connector 70 is fit to the receptacle connector 10. For this reason, the side wall portions 74 to 77 form a fitting protrusion W having a convex shape as a whole.

Each of the side wall portions 74 and 75 is located near each long side of the bottom wall portion 73, and extends in the Y direction along the long side. Each of the side wall portions 76 and 77 is located near each short side of the bottom wall portion 73, and extends in the X direction along the short side. For this reason, the side wall portions 74 and 75 oppose each other, and the side wall portions 76 and 77 oppose each other. Therefore, the fitting protrusion W has a quadrangular tubular shape. The center wall portion 20 of the receptacle connector 10 is accommodated in an internal space of the fitting protrusion W having the quadrangular tubular shape when the plug connector 70 is fit to the receptacle connector 10.

The housing 71 further has fixed metal fittings 78 and 78 near both ends of the housing 71 in the Y direction, that is, near the side wall portions 76 and 77. Configurations of the fixed metal fittings 78 and 78 provided near the side wall portion 76 and the side wall portion 77 are identical to each other. Thus, hereinafter, the fixed metal fitting 78 provided near the side wall portion 77 will be described, and a description of the fixed metal fitting 78 provided near the side wall portion 76 will be omitted.

In some example embodiments, the fixed metal fitting 78 is made of a metal member. The fixed metal fitting 78 includes a cover 78a covering the side wall portion 77 and a connection portion 78b connected to a surface of the wiring substrate 90. The connection portion 78b extends outward in the X direction beyond the side wall portions 74 and 75 such that a surface connected to the wiring substrate 90 is substantially flush with the bottom wall portion 73 near the side wall portion 77 in the Y direction.

A plurality of conductive terminals 72 (e.g., ten conductive terminals) is attached to the side wall portion 74. For this reason, on the side wall portion 74, the plurality of conductive terminals 72 is aligned in a row in the Y direction. Another plurality of conductive terminals 72 (e.g., ten conductive terminals) is similarly attached to the side wall portion 75. Configurations of these conductive terminals 72 are identical to each other. Thus, hereinafter, the conductive terminals 72 on the side wall portion 74 will be described, and a description of the conductive terminals 72 on the side wall portion 75 will be omitted.

The conductive terminal 72 includes a plate-shaped conductive material (for example, a metal member). The conductive terminal 72 includes a proximal end 72a, a contact portion 72b, and a fixing portion 72c (see FIGS. 4A to 4E and FIG. 5D). The proximal end 72a extends outward in the X direction from the side wall portion 74 such that a surface connected to the wiring substrate 90 is substantially flush with the bottom wall portion 73 near the bottom wall portion 73. The proximal end 72a is connected to the electrode (not illustrated) of the wiring substrate 90 by solder, etc. when the plug connector 70 is mounted on the wiring substrate 90. The contact portion 72b is contiguous to an end of the proximal end 72a on an inner side in the X direction (an inner wall surface side of the side wall portion 74), extends along the inner wall surface of the side wall portion 74, and comes into contact with the contact portion 13c of the conductive terminal 13 of the receptacle connector 10. As illustrated in FIG. 5D, the contact portion 72b extends from the inner wall surface to an outer wall surface in accordance with a shape of the side wall portion 74, and is configured to contact the contact portion 13c of the conductive terminal 13 of the receptacle connector 10 at two positions of the inner wall surface and the outer wall surface of the side wall portion 74. The fixing portion 72c extends toward the bottom wall portion 73 along the outer wall surface of the side wall portion 74 so as to be located at an end of an outer wall surface of the contact portion 72b, and the end is buried in the side wall portion 74.

(Fit state of Receptacle Connector and Plug Connector)

Next, a description will be given of a fit state of the receptacle connector 10 and the plug connector 70 with reference to FIGS. 5A to 5D. Whereas the “fit state” and a “fitting direction” are described with reference to receptacle and plug type connectors, other types of connections are contemplated herein which include a connector which fits into, onto, or together with a counterpart mating connector. More generally speaking, a “connection state” and a “connecting direction” may be used to refer to any type of connection in which two electrical connectors are operably coupled together.

As illustrated in FIGS. 5A to 5D, when the plug connector 70 is fit to the receptacle connector 10, the fitting protrusion W including the side wall portions 74 to 77 of the plug connector 70 is accommodated in the accommodating recess V of the receptacle connector 10. At the time of fitting, the center wall portion 20 (see FIG. 3D) of the receptacle connector 10 is accommodated in the internal space of the fitting protrusion W having the quadrangular tubular shape.

In a state in which the plug connector 70 is fit to the receptacle connector 10, the contact portion 72b (see FIG. 4D) of the conductive terminal 72 of the plug connector 70 and the contact portion 13c (see FIG. 3A) of the conductive terminal 13 of the receptacle connector 10 are electrically connected to each other by coming into contact with each other.

(Locking Member)

Next, the locking member 30 will be described in detail. In description of the locking member 30, in some example embodiments, the wiring substrate 50 side with respect to the locking member 30 in the Z direction illustrated in FIGS. 2A to 2D corresponds to “down” and the opposite side thereof corresponds to “up”. The locking member 30 is mounted on the receptacle connector 10 to hold the fit state of the plug connector 70 (corresponding to a counterpart connector) and the receptacle connector 10. As illustrated in FIG. 2C, the locking member 30 is mounted on the receptacle connector 10 and the wiring substrate 90 and the plug connector 70 are interposed between the locking member 30 and the receptacle connector 10 after the receptacle connector 10 and the plug connector 70 are fit together. In some example embodiments, the locking member 30 is made of an insulating material containing resin. As illustrated in FIGS. 6A to 6F, the locking member 30 includes a main body 31 corresponding to a plate-shaped body having a substantially rectangular shape, leg portions 32a to 32d provided at four corners of the main body 31, and lock engaging portions 33 and 33 provided at both ends of the main body 31 in the Y direction.

The plug connector 70 is electrically connected and mounted to the wiring substrate 90 by solder connection, etc. The main body 31 interposes the plug connector 70 and the wiring substrate between the main body 31 and the receptacle connector 10 when the locking member 30 is mounted on the receptacle connector 10. The main body 31 includes a contact portion 34 provided at a substantially central portion of the main body 31 in a longitudinal direction (Y direction) and elastic portions 35 and 35 provided at positions (both ends of the main body 31) interposing the contact portion 34 therebetween in the Y direction.

The back surface 90b (see FIG. 7A) of the wiring substrate corresponds to an opposite surface of the wiring substrate 90 with respect to a surface on which the receptacle connector 10 is mounted. When the locking member 30 is mounted on the receptacle connector 10 (details are described below), the contact portion 34 comes into contact with the back surface 90b before the lock engaging portion 33 and the connector engaging portion 11 are engaged with each other. A thickness of the contact portion 34 is greater than a thickness of a portion of the main body 31 other than the contact portion 34, that is, the elastic portion 35 (see FIG. 6F).

The elastic portions 35 and 35 are configured to elastically deform such that the lock engaging portion 33 is disposed at a position at which the lock engaging portion 33 is engaged with the connector engaging portion 11 when the contact portion 34 comes into contact with the back surface 90b of the wiring substrate 90 (details are described below). The elastic portion 35 is thinner than the contact portion 34 and has a thickness that allows elastic deformation. In this way, the locking member 30 may not engage the lock engaging portion 33 with the connector engaging portion 11 when the contact portion 34 merely comes into contact with the back surface 90b (see FIG. 7A) of the wiring substrate 90, and the lock engaging portion 33 may be engaged with the connector engaging portion 11 by elastically deforming the elastic portion 35 downward such that the elastic portion 35 is bent. When the lock engaging portion 33 is engaged with the connector engaging portion 11 in a state in which the elastic portion 35 is elastically deformed so as to generate tension, a lock state may be reliably obtained.

The leg portions 32a to 32d are provided at the four corners of the main body 31 and extend downward from a lower surface 35a of the elastic portion 35 (a surface opposing the wiring substrate 90 at the time of being mounted on the receptacle connector 10, see FIG. 6F). Lower ends of the leg portions 32a to 32d are close to the surface of the wiring substrate 50 (a mounting surface of the receptacle connector 10, see FIG. 1) in the state in which the locking member 30 is mounted on the receptacle connector 10. The leg portions 32a and 32b are provided at one end of the main body 31 in the Y direction, and the leg portions 32c and 32d are provided at the other end of the main body 31 in the Y direction.

The lock engaging portions 33 and 33 are configured to be engaged with the connector engaging portion 11 when the plug connector 70 is interposed between the receptacle connector 10 and the main body 31. The lock engaging portions 33 and 33 are provided at both ends of the main body 31 in the Y direction (that is, proximate to the elastic portion 35). One lock engaging portion 33 is provided at a position interposed between the leg portions 32a and 32b. The other lock engaging portion 33 is provided at a position interposed between the leg portions 32c and 32d . Configurations of the lock engaging portions 33 and 33 provided at both ends of the main body 31 in the Y direction are identical to each other. Thus, hereinafter, the lock engaging portion 33 provided at the position interposed between the leg portions 32c and 32d will be described, and a description of the lock engaging portion 33 provided at the position interposed between the leg portions 32a and 32b will be omitted.

As illustrated in FIG. 6D, the lock engaging portion 33 includes an extending portion 33a that extends downward from the lower surface 35a of the elastic portion 35 and the protrusion 33b that protrudes from a lower end of the extending portion 33a toward the other lock engaging portion 33. The upper surface 33x of the protrusion 33b comes into contact with the lower surface 24x of the protruding piece 24 of the connector engaging portion 11 (see FIG. 7C) when the lock engaging portion 33 is engaged with the connector engaging portion 11.

Further, through-holes 36 and 36 are formed in the main body 31 such that the lock engaging portion 33 can be visually recognized (see FIG. 6A). That is, the through-holes 36 and 36 are formed in the elastic portions 35 and 35 corresponding to both ends of the main body 31 in the Y direction.

(Mounting State of Locking Member)

Next, a description will be given of the state in which the locking member 30 is mounted on the receptacle connector 10 with reference to FIG. 1 and FIGS. 7A to 7C.

As illustrated in FIG. 1 and FIGS. 7A to 7C, in the state in which the locking member 30 is mounted on the receptacle connector 10, the contact portion 34 of the locking member 30 comes into contact with the back surface 90b of the wiring substrate 90. Further, when the elastic portions 35 and 35 are elastically deformed downward (an elastically deformed state is not illustrated), the lock engaging portions 33 and 33 of the locking member 30 are engaged with the connector engaging portions 11 and 11 of the receptacle connector 10. In practice, although not illustrated in FIG. 1 and FIGS. 7A to 7C, when the locking member 30 is mounted on the receptacle connector 10, the elastic portions 35 and 35 located at both ends of the locking member 30 in the Y direction are elastically deformed downward, and thus the locking member 30 has a mountain shape in which a central portion of the locking member 30 in the Y direction serves as an apex.

The locking member 30 is designed to be mounted on the receptacle connector 10 in a state in which the receptacle connector 10 and the plug connector 70 are fully fit together (in contrast to a state corresponding to incomplete fitting, which is so-called “half fitting”). For this reason, half fitting may be prevented by mounting the locking member 30.

As illustrated in FIG. 7C, when the locking member 30 is mounted on the receptacle connector 10, the lock engaging portions 33 and 33 are located to the outside of the connector engaging portions 11 and 11 (the outside in the Y direction), and the protrusions 33b of the lock engaging portions 33 and 33 are engaged with the protruding pieces 24 of the connector engaging portions 11 and 11. More specifically, the lock engaging portion 33 is engaged with the connector engaging portion 11 as a result of the upper surface 33x of the protrusion 33b coming into contact with the lower surface 24x of the protruding piece 24.

(Effect of First Group of Example Embodiments)

Next, a description will be given of the effects of the above-described electrical connector 1.

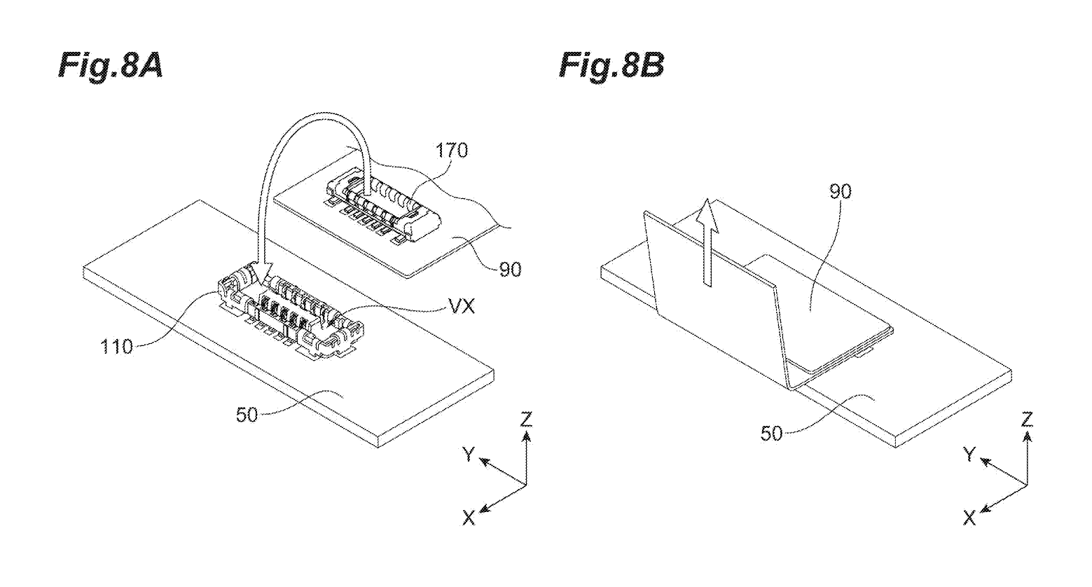

First, a description will be given of an example connection configuration of electrical connectors mounted on a substrate with reference to FIGS. 8A and 8B. As illustrated in FIG. 8A, when a plug connector 170 that is mounted on a wiring substrate 90 is accommodated in an accommodating recess VX of a receptacle connector 110 mounted on a wiring substrate 50, the receptacle connector 110 and the plug connector 170 are fit together, and the electrical connectors mounted on the substrate are connected to each other. The connection configuration may include the case in which the wiring substrate 90 is a relatively soft substrate such as an FPC, etc., as illustrated in FIG. 8B. In such a case, not only may an extraction force be applied to the wiring substrate 90 along the Z direction, but also an extraction force may be applied to the wiring substrate 90 in an oblique direction generated by raising an end of the wiring substrate 90 (an extraction force by tilting). In this case, the connection state may not be sufficiently maintained in a configuration in which the electrical connectors are connected to each other merely by accommodating the plug connector 170 in the accommodating recess VX, thereby fitting the receptacle connector 110 and the plug connector 170 together.

On the other hand, the electrical connector 1 according to the first group of example embodiments includes the receptacle connector 10 mounted on the wiring substrate 50 by solder connection, etc. and electrically connected thereto. The electrical connector 1 also includes the locking member 30 mounted on the receptacle connector 10 to hold the fit state between the receptacle connector 10 and the plug connector 70 corresponding to the counterpart connector. Additionally, the receptacle connector 10 includes the connector engaging portions 11 and 11 that can be engaged with the locking member 30, and the locking member 30 includes the main body 31 interposing the plug connector 70 fit to the receptacle connector 10 between the main body 31 and the receptacle connector 10 at the time of being mounted on the receptacle connector 10. The locking member 30 also includes the lock engaging portions 33 and 33 that can be engaged with the connector engaging portion 11when the plug connector 70 is interposed between the receptacle connector 10 and the main body 31.

In the electrical connector 1 according to the first group of example embodiments, in a state in which the plug connector 70 fit to the receptacle connector 10 is interposed between the main body 31 of the locking member 30 and the receptacle connector 10, the lock engaging portions 33 and 33 of the locking member 30 may be engaged with the connector engaging portions 11 and 11 of the receptacle connector 10. In this way, the locking member 30 and the receptacle connector 10 are connected to each other in a state of interposing the plug connector 70 therebetween. In this way, a force (tension) is applied to the receptacle connector 10 and the plug connector 70 by the locking member 30 in a direction of maintaining the fit state. As a result, the fit state (connection state) between the receptacle connector 10 and the plug connector 70 may be securely maintained as compared to a configuration in which the receptacle connector 10 and the plug connector 70 are merely fit together without a locking member.

In some example embodiments, the mounting position of the locking member 30 may be set to the wiring substrate 50 rather than the receptacle connector 10. However, the receptacle connector 10 and the plug connector 70 may more effectively (directly) generate a force (tension) in the direction of maintaining the fit state by setting the mounting position to the receptacle connector 10 rather than the wiring substrate 50.

The receptacle connector 10 has the plurality of conductive terminals 13 and has the connector engaging portions 11 and 11 at both ends in the Y direction corresponding to the array direction of the plurality of conductive terminals 13, and the locking member 30 includes the lock engaging portions 33 and 33 that can be engaged with the connector engaging portions 11 and 11 at both respective ends of the main body 31 in the Y direction. When the engaging portions provided at both respective both of the receptacle connector 10 and the locking member 30 are engaged with each other, the receptacle connector 10 and the locking member 30 are connected by a stronger force, and the connection state between the receptacle connector 10 and the plug connector 70 is more securely maintained.

The main body 31 interposes the plug connector 70 and the wiring substrate 90 to which the plug connector 70 is electrically connected between the main body 31 and the receptacle connector 10 at the time of being mounted on the receptacle connector 10. The main body 31 includes the contact portion 34 that comes into contact with the back surface 90b of the wiring substrate 90 before the lock engaging portions 33 and 33 are engaged with the connector engaging portions 11 and 11. Additionally, the elastic portions 35 and 35 are configured to elastically deform such that the lock engaging portions 33 and 33 are disposed at engagement positions with respect to the connector engaging portions 11 and 11 in the state in which the contact portion 34 comes into contact with the wiring substrate 90. In this way, in the locking member 30, the lock engaging portions 33 and 33 are engaged with the connector engaging portions 11 and 11 when the elastic portions 35 and 35 are elastically deformed. In this way, the lock engaging portions 33 and 33 in a tensioned state may be engaged with the connector engaging portions 11 and 11, the receptacle connector 10 and the locking member 30 are connected by a stronger force, and the connection state between the receptacle connector 10 and the plug connector 70 may be more securely maintained.

Such a locking member 30 is mounted on the receptacle connector 10 from an upper side in the Z direction after the receptacle connector 10 and the plug connector 70 are fit together. That is, a fitting direction of the connectors is the same as a mounting direction of the locking member 30. In this way, a locking operation may be easily performed.

The thickness of the contact portion 34 is greater than a thickness of a portion of the main body 31 other than the contact portion 34, that is, the contact portion 34 is thicker than the elastic portions 35 and 35. In this way, the contact portion 34 may be easily brought into contact with the wiring substrate 90. Accordingly, the above-described configuration may be realized in which the contact portion 34 is brought into contact with the wiring substrate 90 before the lock engaging portions 33 and 33 are engaged with the connector engaging portions 11 and 11 and the elastic portions 35 and 35 are elastically deformed in response to the initial contact.

The contact portion 34 is provided at a substantially central portion between the pair of lock engaging portions 33 and 33 in an opposing direction (Y direction) in the main body 31, and the elastic portions 35 and 35 are provided at positions between the contact portion 34 and the the pair of lock engaging portions 33 and 33 in the Y direction. In this way, the elastic portions 35 and 35 and the lock engaging portions 33 and 33 are provided close to each other at both end parts of the locking member 30 in the Y direction. When the elastic portions 35 and 35 provided at both ends of the main body 31 are elastically deformed, tension applied to the lock engaging portions 33 and 33 at both ends in the Y direction operates to more securely maintain the connection state between the receptacle connector 10 and the plug connector 70.

The receptacle connector 10 further includes fixed metal fittings 22 and 22 used for fixing to the wiring substrate 50. In some example embodiments, all the lock engaging portions 33 and 33 and the connector engaging portions 11 and 11 contain resin, and the fixed metal fittings 22 and 22 are included in parts of the connector engaging portions 11 and 11. When the fixed metal fittings 22 and 22 used to fix the receptacle connector 10 to the wiring substrate 50 are caused to function as the parts of the connector engaging portions 11 and 11, the strength of the connector engaging portions 11 and 11 may be improved, and an engaged state of the lock engaging portions 33 and 33 and the connector engaging portions 11 and 11 may be strengthened.

The upper surface 33x of the protrusion 33b and the lower surface 24x of the protruding piece 24, both of which may be made of resin, come into contact with the lock engaging portions 33 and 33 and the connector engaging portions 11 and 11 in their respective engagement positions. In this way, when members that into contact with each other at the engagement positions are made of the same or similar material, the hardness of the members coming into contact with each other may be set to the same level, and damage due to cutting of a part, etc., may be prevented.

In addition, for example embodiments in which all the locking member 30 are made of resin, and a part of the connector engaging portions 11 and 11 is used as the fixed metal fitting 22, even in the situation in which an excessive force is applied to a member in an engaged state, the lock engaging portion 33 of the locking member 30 made of resin is damaged before the connector engaging portions 11 and 11 having the fixed metal fitting 22. In this way, damage to the relatively expensive receptacle connector 10 may be avoided.

The through-holes 36 and 36 are formed in the main body 31 such that the lock engaging portion 33 and 33 can be visually recognized. In this way, the appropriate engagement of the lock engaging portions 33 and 33 with the connector engaging portions 11 and 11 may be visually recognized from the through-holes 36 and 36.

[Second Group of Example Embodiments]

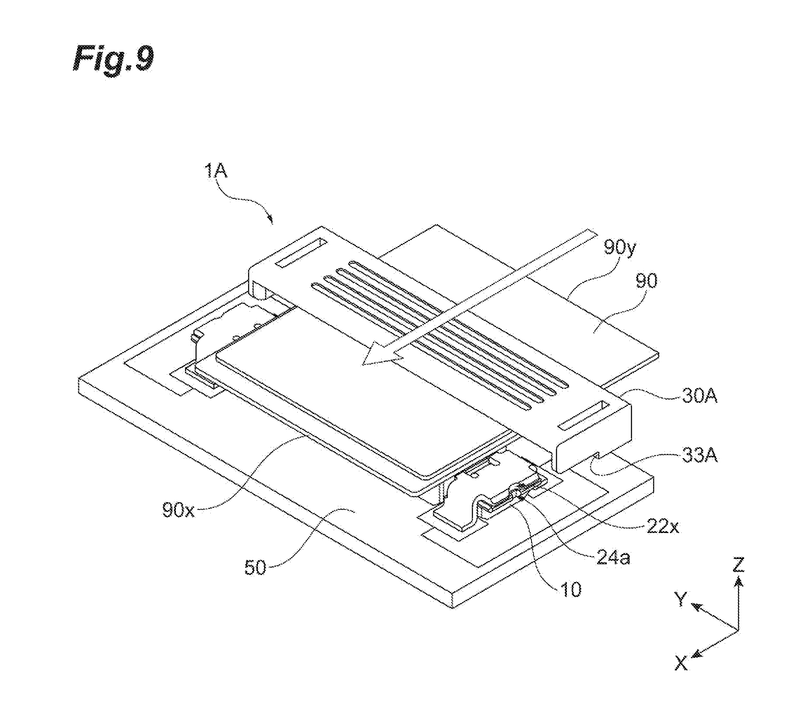

Next, a description will be given of an electrical connector 1A according to a second group of example embodiments with reference to FIGS. 9 to 11C. In the description of the second group of example embodiments, a difference from the above first group of example embodiments will be mainly described.

(Outline of Electrical Connector)

As illustrated in FIG. 9, in the electrical connector 1A of the second group of example embodiments, when a locking member 30A slides (moves) in the X direction along an extending direction of a wiring substrate 90, the lock engaging portions 33A and 33A are disposed at engagement positions with respect to connector engaging portions 11 and 11. The wiring substrate 90 is mounted with a receptacle connector 10 at one end 90x in the extending direction. For this reason, the locking member 30A slides in a direction from the other end 90y to the one end 90x of the wiring substrate 90 in the extending direction. Hereinafter, a description will be given for example embodiments in which the one end 90x corresponds to the “front” and the other end 90y corresponds to the “rear” in the X direction (the extending direction of the wiring substrate 90)

(Locking Member)

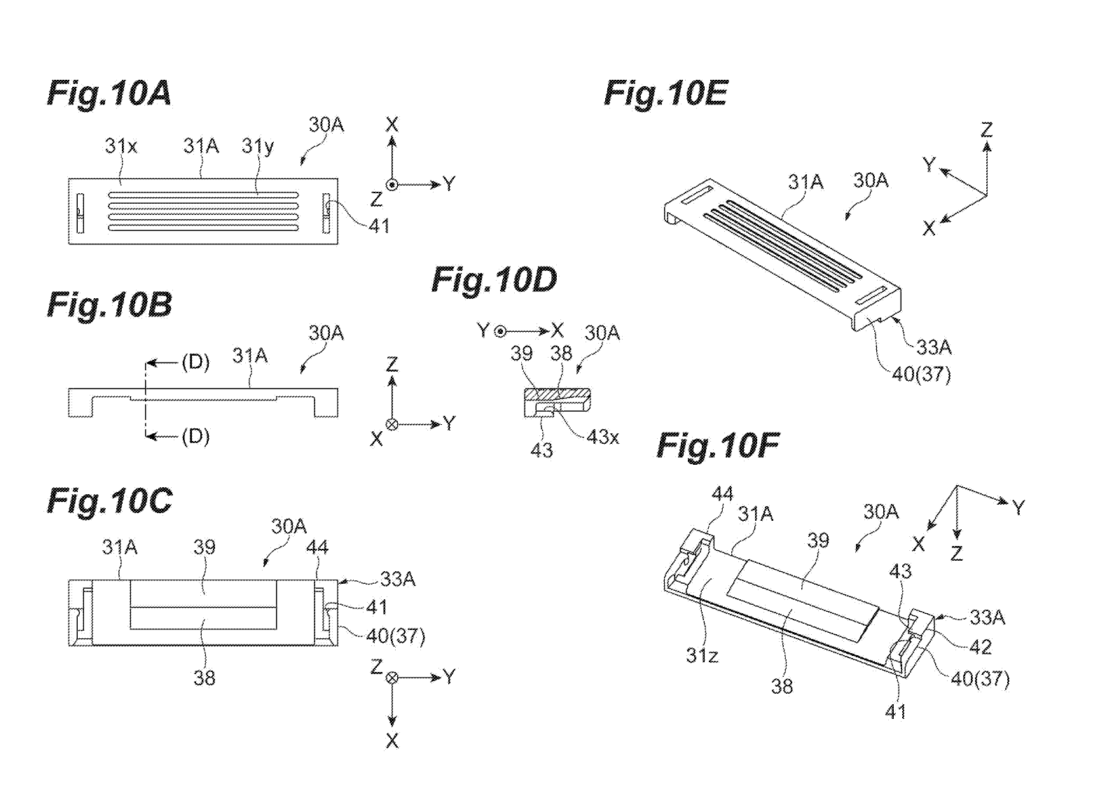

As illustrated in FIGS. 10A to 10F, the locking member 30A includes a main body 31A corresponding to a plate-shaped body having a substantially rectangular shape, guide portions 37 and 37 provided at both ends of the main body 31A in the Y direction, and lock engaging portions 33A and 33A provided at the both ends of the main body 31A in the Y direction. In the description of the locking member 30A for some example embodiments, the wiring substrate 50 side with respect to the locking member 30A in the Z direction illustrated in FIG. 9 corresponds to “down” and the opposite side thereof corresponds to “up”.

As illustrated in FIG. 10C, the main body 31A includes a first contact portion 38 and a second contact portion 39 at a substantially central portion in the Y direction. The first contact portion 38 is configured to come into contact with a back surface 90b of the wiring substrate 90 before the lock engaging portion 33A and the connector engaging portion 11 are completely engaged, that is, while the locking member 30A slides (moves). The second contact portion 39 is configured to come into contact with the back surface 90b of the wiring substrate 90 when the lock engaging portion 33A and the connector engaging portion 11 are completely engaged, that is, after the locking member 30A slides (moves). A thickness of the second contact portion 39 is generally greater than a thickness of the first contact portion 38. However, at a position in which the first contact portion 38 is connected to the second contact portion 39, the first contact portion 38 has a thickness substantially equal to that of the second contact portion 39. The first contact portion 38 is provided in front of the second contact portion 39 in the X direction, and is formed in an inclined shape to become gradually thicker from a front end toward a rear end in the X direction (see FIG. 10D). As illustrated in FIG. 10C, in the X direction, a position at which the first contact portion 38 and the second contact portion 39 are contiguous to each other substantially coincides with positions of the front ends of the lock engaging portions 33A and 33A. Both ends of the main body 31A in the Y direction may correspond to an elastically deformable elastic portion similar to the locking member 30 of the first group of example embodiments.

A plurality of (for example, four) groove portions 31y is formed along the Y direction on an upper surface 31x of the main body 31A (see FIG. 10A). In this way, the groove portions 31y may be used as a slip stop when the locking member 30A is slid, thereby improving operability.

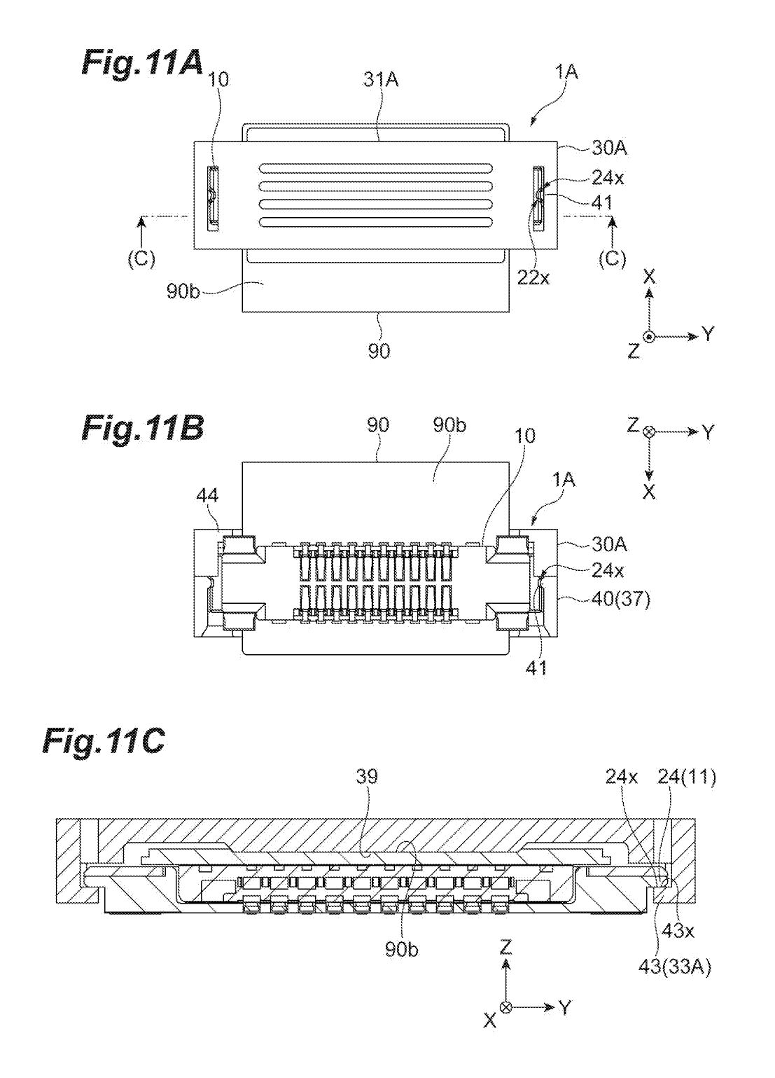

The guide portions 37 and 37 are configured to guide movement of the lock engaging portions 33A and 33A in the X direction along the wiring substrate 90. The guide portions 37 and 37 include wall portions 40 and 40 that extend in the X direction corresponding to a direction in which the lock engaging portion 33A moves. Additionally, the wall portions 40 and 40 interpose a pair of connector engaging portions 11 and 11 in the Y direction corresponding to an opposing direction of the connector engaging portions 11 and 11 (see FIG. 11C).

The wall portions 40 and 40 are provided in a whole region in the X direction along the short sides of the main body 31A at both ends of the main body 31A in the Y direction, and extend downward from a lower surface 31z of the main body 31A (a surface opposing the wiring substrate 90 at the time of being mounted on the receptacle connector 10, see FIG. 10F). On a surface opposing the connector engaging portion 11 of the receptacle connector 10 in the Y direction, each of the wall portions 40 and 40 has a projection 41 protruding toward the opposed connector engaging portion 11. The projections 41 and 41 are provided at substantially central portions in the X direction in the wall portions 40 and 40. As described in the first group of example embodiments, a recess 24a is formed in a protruding piece 24 of the receptacle connector 10, a recess 22x is formed in a fixed metal fitting 22, and formation positions of these recesses 24a and 22x in the X direction substantially coincide with each other. The projections 41 and 41 are provided at positions at which the projections 41 and 41 are fit into the recesses 24a and 22x when the lock engaging portion 33A and the connector engaging portion 11 are engaged with each other (FIG. 3D and FIG. 7A).

The lock engaging portions 33A and 33A are configured to engage the connector engaging portions 11 and 11 by moving in a direction from the other end 90y to the one end 90x of the wiring substrate 90 (see FIG. 9) corresponding to the X direction in accordance with guidance of the guide portions 37 and 37. The lock engaging portions 33A and 33A are disposed at rear ends in the X direction corresponding to a direction in which the lock engaging portions 33A and 33A move at both ends of the main body 31A in the Y direction. More specifically, the lock engaging portions 33A and 33A are provided across the rear ends in the X direction from positions continuous with the projections 41 (that is, substantially central portions in the X direction) in the X direction. In this way, the lock engaging portions 33A and 33A are provided at the rear ends of the main body 31A in the X direction (but are not provided at the front ends of the main body 31A in the X direction), and have lengths in the X direction shorter than the main body 31A. In the X direction, the positions of the lock engaging portions 33A and 33A that are contiguous with the projections 41 and 41 (the front ends of the lock engaging portions 33A and 33A) substantially coincide with positions at which the first contact portion 38 and the second contact portion 39 are connected to each other. In the X direction, a formation position of the lock engaging portion 33A substantially coincides with a formation position of a front end part of the second contact portion 39. Configurations of the lock engaging portions 33A and 33A at both ends in the Y direction are identical to each other. Thus, hereinafter, one lock engaging portion 33A will be described.

The lock engaging portion 33A includes an extending portion 42 that extends further downward from a lower end of the wall portion 40 and a protrusion 43 that protrudes toward the second contact portion 39 from a lower end of the extending portion 42 (see FIG. 10F). An upper surface 43x (see FIG. 10D) of the protrusion 43 comes into contact with a lower surface 24x of the protruding piece 24 of the connector engaging portion 11 when the lock engaging portion 33A is engaged with the connector engaging portion 11 (see FIG. 11C).

The locking member 30A further includes regulation walls 44 and 44 (regulation portions), each of which regulates further movement of the lock engaging portion 33A in a direction from a rear side to a front side in the X direction corresponding to the direction in which the lock engaging portion 33A moves, in a state in which the lock engaging portion 33A is engaged with the connector engaging portion 11. The regulation walls 44 and 44 are provided at rear ends in the X direction and at both ends of the main body 31A in the Y direction. The regulation walls 44 and 44 are provided at both ends in the Y direction along the long sides of the main body 31A, and extend downward from the lower surface 31z of the main body 31A. The regulation walls 44 and 44 regulate forward movement of the lock engaging portion 33A in the X direction by coming into contact with the rear end of the receptacle connector 10.

(Mounted State of Locking Member)

Next, a description will be given of a state in which the locking member 30A is mounted on the receptacle connector 10 with reference to FIG. 9 and FIGS. 11A to 11C.

As illustrated in FIG. 9 and FIGS. 11A to 11C, in a state in which the locking member 30A slides in the X direction along the wiring substrate 90, and the locking member 30A is mounted on the receptacle connector 10, the second contact portion 39 of the locking member 30A comes into contact with the back surface 90b of the wiring substrate 90. The locking member 30A may slide in the X direction along the wiring substrate 50 on which the receptacle connector 10 is mounted in addition to the wiring substrate 90. Further, the lock engaging portions 33A and 33A are disposed at engagement positions with respect to the connector engaging portions 11 and 11 by being guided by the wall portions 40 and 40 of the guide portions 37 and 37. As illustrated in FIG. 11C, the protrusion 43 of the lock engaging portion 33A is engaged with the protruding piece 24 of the connector engaging portion 11. More specifically, the lock engaging portion 33A and the connector engaging portion 11 are engaged with each other such that the upper surface 43x of the protrusion 43 comes into contact with the lower surface 24x of the protruding piece 24.

As illustrated in FIGS. 11A and 11B, in the state in which the locking member 30A is mounted on the receptacle connector 10, at both ends of the main body 31A in the Y direction, the projections 41 extending from the wall portions 40 and 40 are fit into the recesses 24a and 22x of the connector engaging portion 11. In addition, as illustrated in FIG. 11B, at both ends of the main body 31A in the Y direction, the regulation walls 44 and 44 come into contact with the rear end of the receptacle connector 10.

(Effects of Second Group of Example Embodiments)

Next, a description will be given of effects of the electrical connector 1A described above.

In the electrical connector 1A, the locking member 30A includes the guide portions 37 and 37 that guide movement of the lock engaging portions 33A and 33A along the wiring substrate 90. Additionally, the lock engaging portions 33A and 33A are engaged with the connector engaging portions 11 and 11 by moving in accordance with guidance of the guide portions 37 and 37.

In this way, the lock engaging portions 33A and 33A may be engaged with the connector engaging portions 11 and 11 by being moved in a direction intersecting or that is transverse to the fitting direction of the receptacle connector 10 and the plug connector 70, that is, the direction along the wiring substrate 90. In this way, when the lock engaging portions 33A and 33A are engaged in a different direction from the fitting direction, an engagement operation is facilitated, and the connection state between the receptacle connector 10 and the plug connector 70 may be more securely maintained.

The locking member 30A includes the regulation walls 44 and 44 that regulate further movement of the lock engaging portions 33A and 33A in the direction in which the lock engaging portions 33A and 33A move when the lock engaging portions 33A and 33A are engaged with the connector engaging portions 11 and 11. In this way, the lock engaging portions 33A and 33A are inhibited from moving beyond the engagement positions with respect to the connector engaging portions 11 and 11, and the lock engaging portions 33A and 33A may be appropriately positioned with respect to the connector engaging portions 11 and 11.

The guide portions 37 and 37 include the pair of wall portions 40 and 40 that extends in the direction in which the lock engaging portions 33A and 33A move and interposes, or are located to the outside of, the connector engaging portions 11 and 11 in the opposing direction of the pair of connector engaging portions 11 and 11. The wall portions 40 and 40 include the projections 41 that protrude toward the connector engaging portions 11 and 11, and the connector engaging portions 11 and 11 include the recesses 24a and 22x into which the projections 41 fit when the lock engaging portions 33A and 33A are engaged with the connector engaging portions 11 and 11. When the projections 41 are fit into the recesses 24a and 22x, the lock engaging portions 33A and 33A may be appropriately positioned with respect to the connector engaging portions 11, give a click feeling to an operator, and allow the operator to detect engagement.

The lengths of the lock engaging portions 33A and 33A in the X direction are shorter than the length of the main body 31A in the X direction. When the lengths of the lock engaging portions 33A and 33A are short, the moving distances of the lock engaging portions 33A and 33A may be decreased in accordance with the guide portions 37 and 37, and the locking member 30A may be mounted with respect to the receptacle connector 10 even in a limited space.

The lock engaging portions 33A and 33A are disposed at the rear ends of the locking member 30A in the X direction corresponding to the direction in which the lock engaging portions 33A and 33A move. In this way, the lock engaging portions 33A and 33A may be moved by the lengths of the lock engaging portions 33A and 33A and the locking member 30A may be mounted with respect to the receptacle connector 10 in a more limited space.

The wiring substrate 90 is mounted with the plug connector 70 at the one end 90x in the extending direction, and the lock engaging portions 33A and 33A move in the extending direction of the wiring substrate 90 from the other end 90y to the one end 90x in accordance with guidance of the guide portions 37 and 37. In this way, the lock engaging portions 33A and 33A are initially disposed at the other end of the locking member 30A at which the wiring substrate 90 extends. In a configuration in which the wiring substrate 90 is set to the FPC, etc., the other end 90y of the wiring substrate 90 may be raised and tilted. In this case, an extraction force due to tilting of the wiring substrate 90 may be inadvertently applied to the locking member 30A. On the other hand, when the positions of the lock engaging portions 33A and 33A in the locking member 30A are set to the other end at which the wiring substrate 90 extends, the locking member 30A may be inhibited from being detached from the receptacle connector 10 due to extraction by tilting.

The main body 31A includes the first contact portion 38 that is configured to come into contact with the wiring substrate 90 before the lock engaging portion 33A and the connector engaging portion 11 are completely engaged. Additionally, the main body 31 includes the second contact portion 39 that is configured to come into contact with the wiring substrate 90 when engagement of the lock engaging portion 33A and the connector engaging portion 11 is completed. The thickness of the second contact portion 39 is generally greater than the thickness of the first contact portion 38. In a step before engagement is completed, that is, in a state in which the locking member 30A moves with respect to the receptacle connector 10, smooth movement of the locking member 30A is allowed as a result of the first contact portion 38 having a relatively small thickness coming into contact with the wiring substrate 90. In a step in which engagement is completed, the wiring substrate 90 may be favorably pressed by the main body 31A (more specifically, the second contact portion 39) at the time of engagement as a result of the second contact portion 39 having a relatively large thickness coming into contact with the wiring substrate 90.

The first contact portion 38 is formed in an inclined shape to become gradually thicker from a front end toward a rear end in a direction in which the lock engaging portion 33A moves. In this way, a configuration may be adopted in which a pressing force on the wiring substrate 90 by the first contact portion 38 is small when the movement starts, and the pressing force on the wiring substrate 90 by the first contact portion 38 is gradually increased as the movement progresses. In this way, movement of the locking member 30A becomes smoother, and the locking member 30A may be favorably moved with respect to the receptacle connector 10.

### MODIFIED EXAMPLE

It is to be understood that not all aspects, advantages and features described herein may necessarily be achieved by, or included in, any one particular example embodiment. Indeed, having described and illustrated various examples herein, it should be apparent that other examples may be modified in arrangement and detail. We claim all modifications and variations coming within the spirit and scope of the subject matter claimed herein. For example, even though some example embodiments have been described in which the wiring substrate 50 corresponds to the printed circuit board, and the wiring substrate 90 corresponds to the FPC, the invention is not limited thereto, and various electronic circuits may be used as the wiring substrates 50 and 90.

In addition, in the first group of example embodiments, the contact portion 34 may be brought into contact with the back surface 90b of the wiring substrate 90 before the lock engaging portion 33 is engaged with the connector engaging portion 11 by setting the thickness of the contact portion 34 to be greater than that of the elastic portion 35. However, the invention is not limited thereto. For example, a configuration may be adopted in which the main body of the locking member is formed to have a U-shaped cross section, and a central portion in the Y direction may be configured to come into contact with the wiring substrate earlier than both ends in the Y direction. In such a locking member, when the elastic portion and the lock engaging portion are provided at both ends in the Y direction, both ends in the Y direction may be bent downward, and the lock engaging portion may be engaged in a state in which tension is favorably applied.

In addition, in the first group of example embodiments, a description has been given of a configuration in which engagement strength may be improved by elastically deforming the elastic portion 35 to favorably apply tension to the lock engaging portion 33. However, in some example embodiments the engagement strength may be improved by applying a pressing force using a separate spring, etc.

In addition, for some example embodiments the locking member 30 may be made of an insulating material containing resin. However, the invention is not limited thereto, and the locking member may contain metal or other types of suitable material.

What is claimed is:

1. An electrical connector comprising:
a first connector electrically connected to a first substrate; and
a locking member mounted on the first connector and configured to maintain a fit state between the first connector and a second connector corresponding to a counterpart connector,
wherein the first connector includes a connector engaging portion configured to be engaged with the locking member, and wherein the locking member includes:
a main body configured to interpose the second connector between the main body and the first connector when the main body is being mounted on the first connector that is fit to the second connector, and
a lock engaging portion configured to be engaged with the connector engaging portion when the second connector is interposed between the first connector and the main body.

2. The electrical connector according to claim 1,
wherein the first connector includes a plurality of conductive contacts and a pair of connector engaging portions including the connector engaging portion and a second connector engaging portion,
wherein the connector engaging portion is located at a first end of the first connector and the second connector engaging portion is located at a second end of the first connector opposite to the first end in an array direction of the plurality of conductive contacts,
wherein the locking member includes a pair of lock engaging portions including the lock engaging portion and a second lock engaging portion located at an opposite end of the main body of the locking member from the lock engaging portion, and
wherein the lock engaging portion is configured to be engaged with the connector engaging portion at the first end of the first connector and the second lock engaging portion is configured to be engaged with the second connector engaging portion at the second end of the first connector.

3. The electrical connector according to claim 2,
wherein the second connector and a second substrate to which the second connector is electrically connected are interposed between the main body and the first connector when the main body is mounted on the first connector,
wherein the main body includes a contact portion configured to come into contact with the second substrate before the lock engaging portion is engaged with the connector engaging portion, and
wherein an elastic portion is configured to elastically deform such that the lock engaging portion is disposed at an engagement position with respect to the connector engaging portion when the contact portion comes into contact with the second substrate.

4. The electrical connector according to claim 3, wherein a thickness of the contact portion is greater than thicknesses associated with other portions of the main body.

5. The electrical connector according to claim 4,
wherein at least a portion of the contact portion is provided at a central portion of the main body between the pair of lock engaging portions, and
wherein the elastic portion comprises two elastic portions located on opposite sides of the contact portion and in between the contact portion and the pair of lock engaging portions.

6. The electrical connector according to claim 2,
wherein the second connector and a second substrate to which the second connector is electrically connected are interposed between the main body and the first connector when the main body is mounted on the first connector,
wherein the locking member further includes guide portions configured to guide movement of the lock engaging portion along the second substrate, and
wherein the lock engaging portion is configured to become engaged with the connector engaging portion in response to the movement of the lock engaging portion being guided by the guide portion.

7. The electrical connector according to claim 6, wherein the locking member further includes one or more regulation portions configured to, when the lock engaging portion is engaged with the connector engaging portion, regulate further movement of the lock engaging portion in a direction in which the lock engaging portion moves.

8. The electrical connector according to claim 6,
wherein the guide portions include a pair of wall portions which extend in a direction in which the lock engaging portion moves and are located outside of the pair of connector engaging portions along a lengthwise direction of the main body,
wherein at least one of the wall portions includes a projection configured to protrude toward the connector engaging portion, and
wherein the connector engaging portion includes a recess into which the projection is fit when the lock engaging portion is engaged with the connector engaging portion.

9. The electrical connector according to claim 6, wherein a length of the lock engaging portion in a direction in which the lock engaging portion moves is shorter than a length of the main body in the direction in which the lock engaging portion moves.

10. The electrical connector according to claim 9, wherein the lock engaging portion is disposed at a rear end of the locking member in the direction in which the lock engaging portion moves.

11. The electrical connector according to claim 10,
wherein the second connector is mounted at one end of the second substrate opposite to an other end of the second substrate in an extending direction, and
wherein the lock engaging portion is configured to move from the other end to the one end in the extending direction of the second substrate in accordance with guidance of the guide portions.

12. The electrical connector according to claim 11,
wherein the main body includes:
a first contact portion configured to come into contact with the second substrate before the lock engaging portion is completely engaged with the connector engaging portion; and
a second contact portion configured to come into contact with the second substrate when the lock engaging portion is completely engaged with the connector engaging portion, and
wherein a thickness of the second contact portion is greater than a thickness of the first contact portion.

13. The electrical connector according to claim 12, wherein the first contact portion comprises an inclined shape that becomes gradually thicker from a front side toward a rear side in the direction in which the lock engaging portion moves.

14. The electrical connector according to claim 1,
wherein the first connector further includes a fixed metal fitting that is fixed to the first substrate,
wherein both the lock engaging portion and the connector engaging portion contain resin, and
wherein the fixed metal fitting is included in a part of the connector engaging portion.

15. The electrical connector according to claim 1, wherein a through-hole is formed in the main body such that the lock engaging portion is visually recognizable from the through-hole.

16. The electrical connector according to claim 1,
wherein the first connector is a receptacle connector including an accommodating portion configured to accommodate the second connector, and
wherein the second connector is a plug connector configured to be fit to the first connector by being accommodated in the accommodating portion.

17. An electrical connector comprising:
a first connector mounted on a first substrate and including a connector engaging portion; and
a locking member including:
a main body mounted to the first connector, and
a lock engaging portion configured to engage the connector engaging portion while a second connector mounted on a second substrate is located between the first connector and the main body,
wherein the locking member is configured to securely maintain an electrical connection between the first connector and the second connector when the lock engaging portion is engaged with the connector engaging portion.

18. The electrical connector according to claim 17,
wherein the first connector comprises two connector engaging portions including the connector engaging portion and a second connector engaging portion,
wherein the locking member comprises two lock engaging portions including the lock engaging portion and a second lock engaging portion,
wherein the lock engaging portion is configured to engage the connector engaging portion at a first end of the main body and the second lock engaging portion is configured to engage the second connector engaging portion at a second end of the main body opposite the first end, and
wherein the locking member comprise one or more elastic portions which are configured to elastically deform in response to the two lock engaging portions being engaged with the two connector engaging portions.

19. The electrical connector according to claim 18, wherein the one or more elastic sections are configured to elastically deform during relative movement between the locking member and the first connector, wherein the relative movement is in a direction that is parallel to a connecting direction of the first connector and the second connector.

20. The electrical connector according to claim 18, wherein the one or more elastic sections are configured to elastically deformed during relative sliding movement between the locking member and the first connector, wherein the relative movement is in a direction that is transverse to a connecting direction of the first connector and the second connector.
